(19) United States
(12) Patent Application Publication
(10) Pub. No.: US 2006/0294363 A1
(43) Pub. Date: Dec. 28, 2006

(54) System and method for tunnel management over a 3G-WLAN interworking system

(75) Inventors: Eun-Hui Bae, Seoul (KR); R. Rajavelsamy, Bangalore (IN); Jeedigunta Venkateswar, Bangalore (IN)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Elecontronics Co., Ltd.

(21) Appl. No.: 11/454,130

(22) Filed: Jun. 16, 2006

(30) Foreign Application Priority Data
Jun. 16, 2005 (IN) 734/CHE/2005

(51) Int. Cl. H04L 9/00

(52) U.S. Cl. 713/153

(57) ABSTRACT

Method and system for facilitating tunnel management in the 3G-WLAN interworking systems providing dynamic configuration of maximum number of IP Security Protocol (IPsec) tunnels allowed per Internet Key Exchange (IKE) Security Association (SA) at the Packet Data Gateway (PDG) during the initial tunnel establishment procedure. Authentication Authorization and Accounting (AAA) server is notified of the new IPsec tunnel established between the user equipment (UE) and the PDG.

### CROSS-REFERENCE TO RELATED PATENT APPLICATION

This application claims the benefit under 35 U.S.C. §119(a) of Indian Provisional Patent Application No. 734/CHE/2005, filed Jun. 16, 2005, in the Indian Intellectual Property Office, the entire disclosure of which is hereby incorporated by reference.

### BACKGROUND OF THE INVENTION

1. Field of the Invention

The present invention relates in general to the field of Third Generation Wireless Local Area Network (3G-WLAN) interworking systems. More particularly, the present invention relates to tunnel management in the 3G-WLAN interworking systems, and provides dynamic configuration of maximum number of IP Security Protocol (IPsec) tunnels allowed per Internet Key Exchange (IKE) Security Association (SA) at the Packet Data Gateway (PDG) during the initial tunnel establishment procedure, and notification of the new IPsec tunnel established between the user equipment (UE) and the PDG to the Authentication, Authorization and Accounting (AAA) server.

2. Description of the Related Art

The 3rd Generation Partnership Project (3GPP) (http://www.3gpp.org) specification TS23.234, the entire content of which is hereby incorporated by reference, deals with the ongoing 3GPP work related to 3G-WLAN interworking and provides a system description for tunnel establishment mechanism between WLAN-3G UE and PDG over a 3G-WLAN interworking system, as depicted in FIG. 1.

FIG. 1 is a conceptual diagram of an exemplary 3G-WLAN interworking system in which an End-To-End Internet Protocol (IP) tunnel is established. The 3G-WLAN interworking system includes UE 100, WLAN 110 and a Public Land Mobile Network (PLMN) 160. The PLMN 160 includes a Wireless Access Gateway (WAG) 120, Packet Data Gateway (PDG) 130, Authentication, Authorization and Accounting (AAA) Server 140 and Home Subscription Server (HSS) 150. The UE 100 is communicably coupled to WLAN 110, which in turn is communicably coupled to both AAA Server 140 and WAG 120. Both HSS 150 and PDG 150 are communicably coupled to AAA Server 140 and PDG 130 is additionally communicably coupled to WAG 120. An End-To-End IP tunnel 170 is established between UE 100 and PDG 130.

Depending on internal configuration, the UE initiates W-APN resolution and tunnel establishment with a PDG in PLMN, as illustrated in FIG. 2 which is a diagram illustrating a process for establishing an UE 100 initiated End-To-End IP tunnel 170, as described in 3GPP TS 33.234. In step 200, WLAN Access Authentication and Authorization and WLAN UE local IP address allocation occurs. In step 210, the UE 100 initiates WLAN Access Point Name (W-APN) resolution and tunnel establishment with PDG 130. Step 210 will now be described in greater detail including substeps 211-214.

In step 211, UE 100 performs a Domain Name Server (DNS) query to resolve the W-APN. The DNS response contains one or more IP addresses of equivalent PDGs 130 that support the requested W-APN in the PLMN 160, according to conventional DNS procedures. If the PLMN 160 does not support the W-APN, then the DNS query returns a negative response. In step 212, UE 100 selects a PDG 130 from the list received in step 211. An End-To-End IP tunnel is then established between UE 100 and the selected PDG 130. The UE 100 includes the W-APN and the user identity of the EU 100 in the initial tunnel establishment request. In step 213, PDG 130 contacts the AAA Server 140 for authentication of the UE 100 and authorization of the requested service. After successful authentication, the AAA server 140 passes key information to the PDG 130 to establish Security Associations (SAs) with the UE 100. In step 214, PDG 130 and WAG 120 exchange information via the AAA Server 140 in order to establish a filtering policy to allow the forwarding of tunneled packets to the PDG 130.

That is, as shown in FIG. 2, UE performs a DNS query to resolve W-APN. The DNS response will contain one or more IP addresses of equivalent PDG's that support the requested W-APN in the PLMN according to standard DNS procedures. If the PLMN does not support the W-APN, then the DNS query returns a negative response.

The UE selects a PDG from the list received in step 200, and the establishment of an end-to-end tunnel is performed between the UE and this PDG. The UE includes the W-APN and the user identity in the initial tunnel establishment request. The PDG and WAG exchange information (via the AAA Server and Proxy) in order to establish a filtering policy to allow the forwarding of tunneled packets to the PDG. The PDG contacts AAA for the tunnel authentication and authorization.

The 3GPP (http://www.3gpp.org) specification TS33.234, the entire content of which is hereby incorporated by reference, which deals with the ongoing 3GPP work related to security of 3G-WLAN interworking, provides a system description for authentication and authorization for secured tunnel establishment mechanism between 3G-WLAN UE and the PDG over a 3G-WLAN interworking system.

Tunnel establishment procedures are provided in the current 3GPP system, as in TS 33.234 and other related specifications. Currently the number of IPsec tunnels per IKE SA is manually configured in the PDG by the operator. Currently, there is no method available to dynamically configure the number of IPsec SA's allowed per IKE SA to control simultaneous tunnel establishment.

The establishment of a new IPsec SA's (under the same IKE SA) does not contact the AAA server and no method exists to intimate the new IPsec tunnel establishment for the same IKE SA by the UE towards the same PDG to the AAA server.

Accordingly, the present state of art in this field, as per 3GPP TS 33.234 for 3G-WLAN interworking system, has at least the drawbacks of: lack of the ability to dynamically configure the number of simultaneous IPsec tunnel allowed per IKE SA at the PDG over a 3G-WLAN interworking system; and lack of the ability to intimate the new IPsec tunnel establishment to the AAA server by the PDG is available.

### SUMMARY OF THE INVENTION

Exemplary embodiments of the present invention provide system and method for tunnel management over a 3G-WLAN interworking system which address at least the above-noted drawbacks

One of the objects of exemplary embodiments of the present invention is to provide a method for tunnel management to a 3G WLAN interworking environment.

Another object of exemplary embodiments of the present invention is to provide a mechanism by which the maximum number of IPsec tunnels allowed per IKE SA is configured dynamically at the PDG.

Another object of exemplary embodiments of the present invention is to provide a mechanism by which the PDG intimate the AAA server about the new IPsec tunnel creation, which may be required for charging, Quality of Service (QoS) parameter mapping and Mobility.

Another object of exemplary embodiments of the present invention is to use the Security Parameter Index (SPI) of the inbound IPsec SA at the PDG as the Tunnel ID by the AAA server.

Accordingly, exemplary embodiments of the present invention provide a system and a method for dynamically configuring the maximum number of IPsec tunnels allowed per IKE SA at the PDG over a 3G-WLAN interworking system.

Exemplary implementations of the embodiments of the present invention may incorporate the mechanism by which the PDG intimate the AAA server about the new IPsec tunnel creation, which may be required for charging, QoS parameter mapping and Mobility.

exemplary embodiments of the present invention provides a system comprising a WLAN-3G capable UE, WLAN network interconnected to a 3GPP delivery network comprising an AAA server, a WAG and PDG and intermediate IP nodes.

Another exemplary embodiments of the present invention provides a method where the number of IPsec tunnels allowed per IKE SA is manually configured in the PDG by the operator. As different applications have different QoS classes and QoS parameters may be agreed to according to the subscription, the number of IPsec SA are configured dynamically at the PDG by the AAA/HSS according to the subscription and W-APN (application).

According to an exemplary implementation of embodiments of the present invention, if the establishment of a new IPsec SA's (for example, under the same IKE SA) does not contact the AAA/HSS server, the AAA Server is made aware of the number of tunnels established.

In an exemplary implementation of embodiments of the present invention, the AAA/HSS server may use the IPsec tunnel information for at least one of: charging (per tunnel charging); supporting Mobility, load balancing (AAA can redirect to new PDG), authorization for the new requested QoS parameters in IPsec SA, redirecting the request to another appropriate PDG, if the requested PDG cannot serve, per tunnel authentication (on W-APN basis), checking user subscription for maximum data rate, QoS on all the simultaneous IPSec SA's to the same W-APN, and controlling the number of IPsec tunnels allowed per UE according to the subscription.

Exemplary embodiments of the present invention provide a system and method for supporting Tunnel Management in 3G-WLAN Interworking System.

Exemplary embodiments of the present invention provide a system and method for controlling simultaneous IPsec tunnel establishment between the UE and the PDG.

Exemplary embodiments of the present invention provide a system and method to configure the number of IPsec tunnels allowed per IKE SA at the PDG dynamically.

Exemplary embodiments of the present invention provide a system and method to intimate the new IPsec tunnel establishment to the AAA server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features, and advantages of certain embodiments of the present invention will be more apparent from the following description taken in conjunction with the accompanying drawings, in which:

FIG. 1 is a conceptual diagram of an exemplary WLAN-3G interworking system, involved in establishing an End-To-End tunnel between UE and PDG.

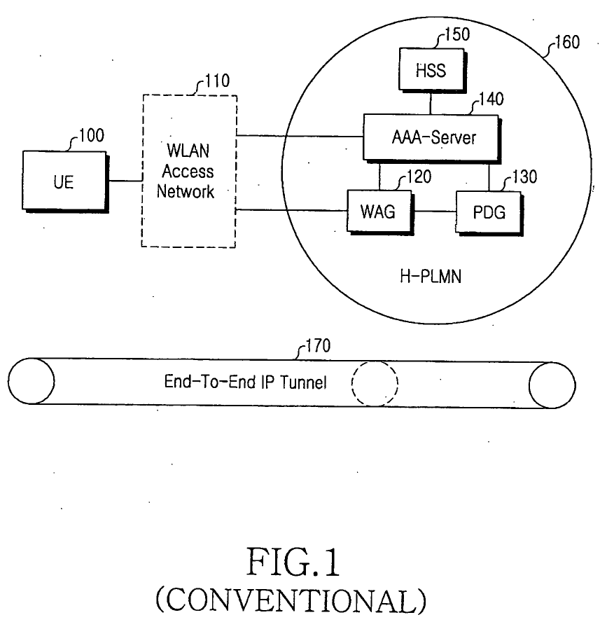

FIG. 2 is a diagram illustrates a sequence of steps for UE initiated Tunnel Establishment towards PDG, forming an End-To-End tunnel, as described in 3GPP TS 23.234.

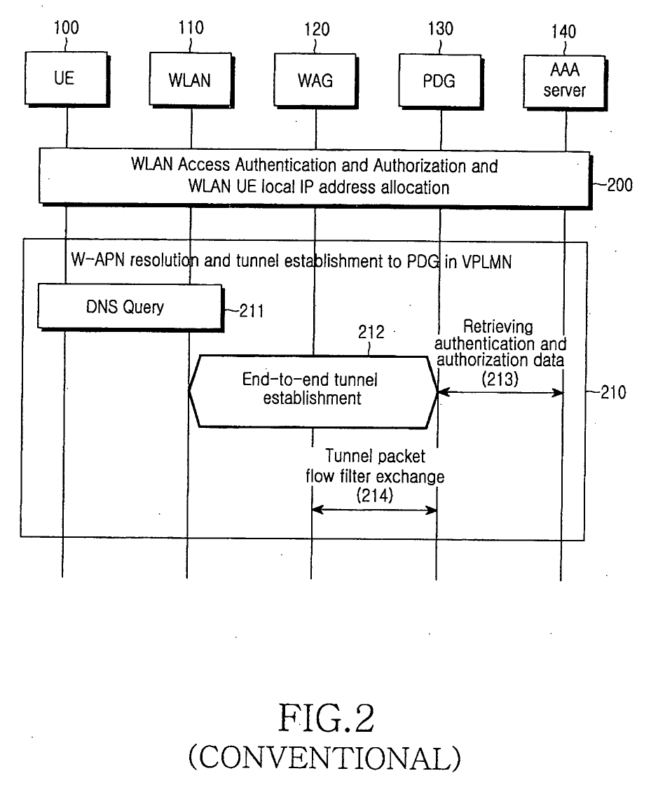

FIG. 3 is a diagram illustrating a message exchange, according to an exemplary embodiment of the present invention, between the UE and the AAA server via the PDG during the initial tunnel establishment procedure.

FIG. 4 is a diagram illustrating a message exchange, according to an exemplary embodiment of the present invention, between the UE and the AAA server via the PDG during the secondary/subsequent tunnels establishment procedure for the same IKE SA.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The following technical terms as listed below are give their customary meaning in this description as will be understood by skilled artisans:
3GPP: 3rd Generation Partnership Project;
AAA: Authentication, Authorization and Accounting;
AP: Wireless Local Area Network (WLAN) Access Point;
AP-id: Wireless Local Area Network (WLAN) Access Point Identity;
APN: Access Point Name;
CSCF: Call Session Control Function;
DNS: Domain Name Server;
GGSN: Gateway GPRS Support Node;
H-PLMN: Home Public Land Mobile Network (PLMN);
HSS: Home Subscription Server;
IP-CAN: IP-Connectivity Access Network;
IPSec: IP Security Protocol;
PDG: Packet Data Gateway;
SDP: Session Description Protocol;
SGSN: Serving GPRS Support Node;
SPI: Security parameter Index;
TID: Tunnel ID;
User terminal: the end user equipment e.g., the Mobile Station (MS) or User Equipment (UE);
V-PLMN: Visited Public Land Mobile Network;
WAG: Wireless Access Gateway;
W-APN: WLAN APN;
WLAN UE: The WLAN UE is the UE (equipped with UICC card including (U)SIM) utilized by a 3GPP subscriber to access the WLAN interworking; and
WLAN UE's remote IP address: An address used in the data packet encapsulated by the WLAN UE-initiated tunnel. It represents the identity of the WLAN UE in the network, which the WLAN UE is accessing.

An exemplary embodiment of the present invention provides a method for facilitating tunnel management over a 3G-WLAN interworking system.

According to an exemplary implementation, a mechanism dynamically configures the maximum number of IPsec tunnels allowed per IKE SA at the PDG over a 3G-WLAN interworking system.

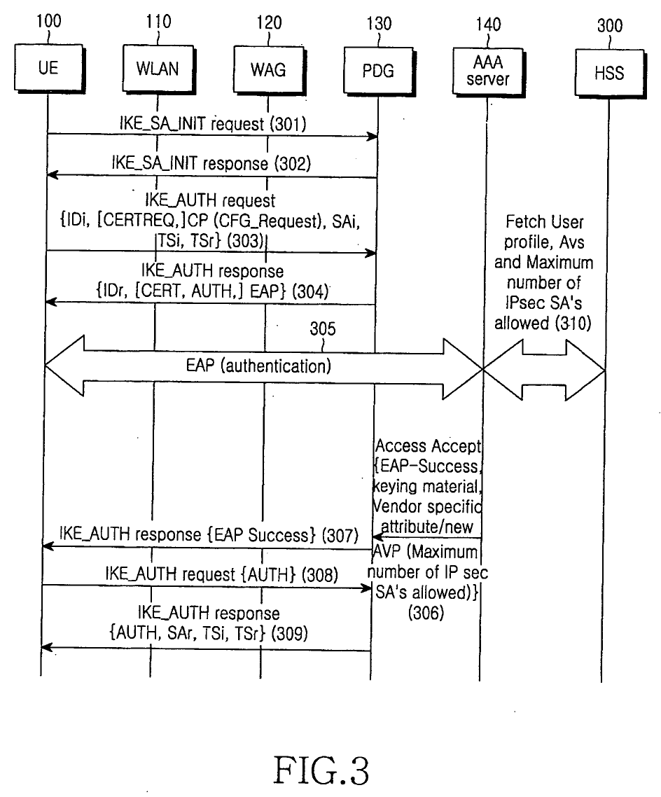

An exemplary embodiment of the present invention provides a system comprising a 3G-WLAN UE establishing an end-to-end tunnel towards a PDG over the 3GPP specified interface as shown in FIG. 3. During the initial tunnel establishment procedure, AAA server 140 fetches the maximum number of tunnels allowed for the W-APN according to the subscription from the Home Subscription Server (HSS) 300 and dynamically configures the number of IPsec SA's allowed per IKE SA at the PDG 130.

The AAA server 140 sending Radius/Diameter authentication success message to the UE 100 via the PDG 130, includes the configuration parameter in the Vendor Specific AVP of Radius/Diameter protocol, the tunneling AVPs of Radius/Diameter protocol, or a newly-defined AVP in Radius/Diameter protocol.

When PDG 130 receives the configuration parameter, that is, the maximum number of allowed IPsec SA's per IKE SA, the PDG 130 configures the parameter and limits the number of secondary/subsequent tunnels establishment by the UE 100 for the same IKE SA.

Referring to an exemplary implementation of an embodiment of the present invention as shown in FIG. 3, in step 301, UE 100 sends an Initial Internet Key Exchange security association (IKE_SA_INIT) request to PDG 130 and in step 302 UE 100 receives an IKE_SA_INIT response from PDG 130. Thereby in steps 301 and 302, the UE 100 and the PDG 130 negotiate an IKE_SA.

In step 303 the UE 100 may directly derive a TSK and use it to calculate the Authentication (AUTH). Here, the UE 100 includes the AUTH payload within the Internet Key Exchange Authentication (IKE_AUTH) request message and sends it to the PDG 130. The IKE_AUTH request message may further include an Identification-Initiator (IDi), Certificate Request ([CERTREQ]), CP (CFG_Request), Security Association-Initiator (SAi), Traffic Selector-Initiator (TSi) and Traffic Selector-Responder (TSr).

In step 304, the PDG 130 sends the IKE_AUTH response message including the AUTH payload to the UE 100. The IKE_AUTH response message may further include an Identification-Responder (IDr), Certificate ([CERT]), and EAP.

In step 305 EAP authentication takes place between UE 100 and AAA server 140, while in step 310 user profile, Average and Maximum number of IPsec SA's allowed are fetched with respect to the AAA server 140 and HSS 300.

In steps 306 and 307, the AAA server 140 sends Radius/Diameter authentication success message to the UE 100 via the PDG 130. The message comprises configuration parameter in the Vendor Specific AVP of Radius/Diameter protocol or the tunneling AVPs of Radius/Diameter protocol or a newly defined AVP in Radius/Diameter protocol.

In step 308, the UE 100 send to the PDG 130 AUTH payload in the IKE_AUTH request message. In step 309, the PDG 130 verifies the AUTH Payload sent by the UE 100 and calculates the AUTH payload using a certificate. Then the PDG 130 sends the IKE_AUTH response message including the AUTH payload to the UE 100. The IKE_AUTH response message may further include Security Association-Responder (SAr), Traffic Selector-Initiator (TSi) and Traffic Selector-Responder (TSr).

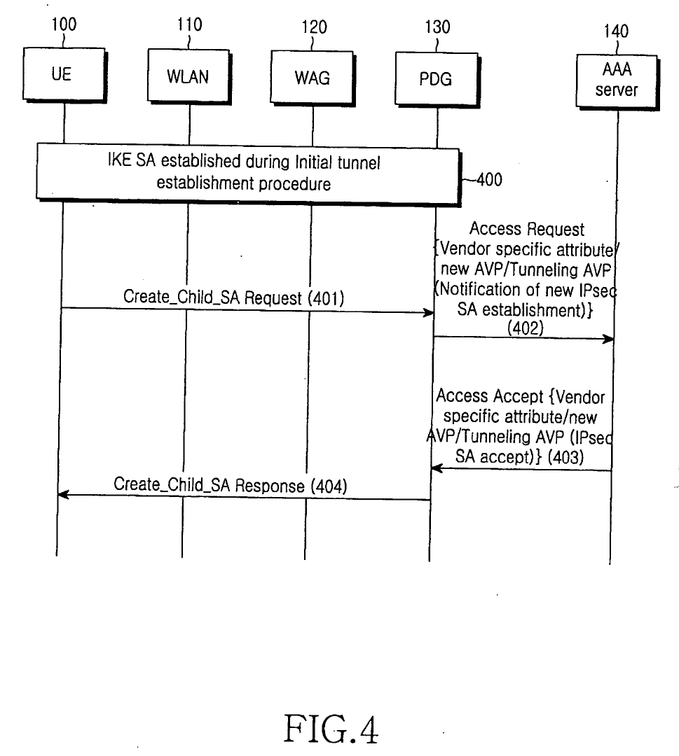

According to an exemplary embodiment of the present invention, when a 3G-WLAN UE 100 request the PDG 130 to establish a secondary/subsequent tunnel 400 for the same IKE SA as shown in the FIG. 4, the 3G-WLAN UE 100 sends in step 401 a Child_Create_SA Request to the PDG 130 to establish the secondary/subsequent tunnel.

Then, the PDG 130 will check the Maximum Number of Tunnels allowed for that particular IKE SA and then in step 402 intimates the AAA server 140 about the IPsec SA establishment. The PDG 130 will intimate the AAA server 140 using the Vendor Specific AVP of Radius/Diameter protocol or by using the tunneling AVPs of Radius/Diameter or by defining a new AVP in Radius/Diameter protocol. The PDG 130 will use the SPI of the inbound IPsec SA as the Tunnel ID (TID) and will intimate the TID to the AAA server 140.

In step 403, AAA server 140 sends the Access Accept/Reject message using the Vendor Specific AVP of Radius/Diameter protocol or by using the tunneling AVPs of Radius/Diameter protocol or by defining a new AVP in Radius/Diameter protocol. AAA server also informs the PDG 130, whether to accept the tunnel request or to redirect the tunnel or to initiate authentication procedure, that is, to initiate new tunnel establishment procedure.

If the PDG 130 receives Access Accept message, then the PDG 130 will send in step 404 the Child_Create_SA Response to the UE 100 and establish the IPsec SA for the secondary/subsequent tunnel.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for facilitating tunnel management in a Third Generation Wireless Local Area Network (3G-WLAN) interworking environment, the method comprising
dynamically configuring a maximum number of IP Security Protocol (IPsec) tunnels allowed per Internet Key Exchange (IKE) Security Association (SA) at a Packet Data Gateway (PDG) over a 3G-WLAN interworking system.

2. The method as claimed in claim 1, wherein the dynamically configuring comprises configuring during an initial tunnel establishment procedure.

3. The method as claimed in claim 1, further comprising the PDG intimating an Authentication, Authorization and Accounting (AAA) server about a creation of an IPsec tunnel between user equipment (UE) and the PDG.

4. The method as claimed in claim 3, wherein the IPsec tunnel is provided for at least one of charging, Quality of Service (QoS) parameter mapping and Mobility.

5. The method as claimed in claim 1, wherein a number of IPsec tunnels allowed per IKE SA is manually configured in the PDG, applications comprise different QoS classes, and QoS parameters are agreed to according to a subscription, and
wherein the number of IPsec SA are configured dynamically at the PDG by and least one of the AAA server and a Home Subscription Server (HSS) according to the subscription and WLAN Access Point Name (W-APN).

6. The method as claimed in claim 1, further comprising:
establishing a new tunnel IPsec SA tunnel; and
if establishing a new tunnel of IPsec SA does not comprise contacting at least one of the AAA server and HSS server, making the AAA Server aware of the number of tunnels established.

7. The method as claimed in claim 3, further comprising at least one of the AAA server and a HSS server using IPsec tunnel information for at least one of:
charging;
supporting Mobility;
load balancing;
authorizing at least one new requested QoS parameter in IPsec SA;
redirecting the request to another PDG, if the requested PDG cannot serve;
per tunnel authentication on W-APN basis;
checking user subscription for a maximum data rate, QoS on simultaneous Sec SA's to the same W-APN; and
controlling the number of IPsec tunnels allowed per UE according to the subscription.

8. The method as claimed in claim 1, further comprising controlling simultaneous IPsec tunnel establishment between user equipment (UE) and the PDG.

9. The method as claimed in claim 1, wherein, during an initial tunnel establishment procedure, AAA server fetches the maximum number of tunnels allowed for the W-APN according to a subscription from the Home Subscription Server (HSS) and performs dynamically configuring of the number of IPsec SA's allowed per IKE SA at the PDG.

10. The method as claimed in claim 1, wherein an AAA server sends Radius/Diameter authentication success message to user equipment (UE) via the PDG.

11. The method as claimed in claim 10, wherein the message comprises at lest one of configuration parameter in a Vendor Specific AVP of Radius/Diameter protocol configuration parameter in a tunneling AVPs of Radius/Diameter protocol, and configuration parameter in a newly-defined AVP in Radius/Diameter protocol.

12. The method as claimed in claim 10, wherein, when PDG receives the configuration parameter, the PDG configures the parameter and limits the number of at least one of secondary and subsequent tunnels established by the UE for the same IKE SA.

13. The method as claimed in claim 10, wherein the configuration parameter comprise the maximum number of allowed IPsec SA's per IKE SA.

14. A system for facilitating tunnel management in a Third Generation Wireless Local Area Network (3G-WLAN) interworking environment, the system comprising a Packet Data Gateway (PDG), wherein
a maximum number of IP Security Protocol (Ipsec) tunnels allowed per Internet Key Exchange (IKE) Security Association (SA) is dynamically configured at the PDG over a 3G-WLAN interworking system.

15. The system as claimed in claim 14, wherein the maximum number of the IPsec tunnels allowed per IKE SA is dynamically configured at the PDG during an initial tunnel establishment procedure.

16. The system as claimed in claim 14, further comprising:
a user equipment (UE); and
an Authentication, Authorization and Accounting (AAA) server;
wherein the PDG is configured to intimate the AAA server about a creation of an IPsec tunnel between the UE and the PDG.

17. The system as claimed in claim 16, wherein the IPsec tunnel is provided for at least one of charging, Quality of Service (QoS) parameter mapping and Mobility.

18. The system as claimed in claim 14 further comprising a Home Subscription Server (HSS),
wherein a number of IPsec tunnels allowed per IKE SA is manually configured in the PDG, applications comprise different QoS classes, and QoS parameters are agreed to according to a subscription, and
wherein the number of IPsec SA are configured dynamically at the PDG by and least one of the AAA server and the HSS according to the subscription and WLAN Access Point Name (W-APN).

19. The system as claimed in claim 14, wherein, if establishing a new tunnel of IPsec SA does not comprise contacting at least one of the AAA server and HSS server, the AAA Server is made aware of the number of tunnels established.

20. The system as claimed in claim 16, further comprising a HSS server, wherein at least one of the AAA server and the HSS server uses IPsec tunnel information for at least one of:
charging;
supporting Mobility;
load balancing;
authorizing at least one new requested QoS parameter in IPsec SA;
redirecting the request to another PDG, if the requested PDG cannot serve;
per tunnel authentication on W-APN basis;
checking user subscription for a maximum data rate, QoS on simultaneous Sec SA's to the same W-APN; and
controlling the number of IPsec tunnels allowed per UE according to the subscription.

21. The system as claimed in claim 14, wherein simultaneous IPsec tunnel establishment between user equipment (IJE) and the PDG is controlled.

22. The system as claimed in claim 14, further comprising:
an AAA server; and
a Home Subscription Server (HSS);
wherein during an initial tunnel establishment procedure, the AAA server fetches the maximum number of tunnels allowed for the W-APN according to a subscription from the HSS and performs dynamically configuring of the number of IPsec SA's allowed per IKE SA at the PDG.

23. The system as claimed in claim 14, further comprising an AAA server, wherein the AAA server sends Radius/Diameter authentication success message to user equipment (UE) via the PDG.

24. The system as claimed in claim 23, wherein the message comprises at lest one of configuration parameter in a Vendor Specific AVP of Radius/Diameter protocol configuration parameter in a tunneling AVPs of Radius/Diameter protocol, and configuration parameter in a newly-defined AVP in Radius/Diameter protocol.

25. The system as claimed in claim 23, wherein, when the PDG receives the configuration parameter, the PDG configures the parameter and limits the number of at least one of secondary and subsequent tunnels established by the UE for the same IKE SA.

26. The system as claimed in claim 23, wherein the configuration parameter comprise the maximum number of allowed IPsec SA's per IKE SA.
